(19) United States
(12) Patent Application Publication
(10) Pub. No.: US 2007/0163650 A1
(43) Pub. Date: Jul. 19, 2007

(54) Chemical dispensing apparatus of FOX process device

(76) Inventors: Jae-Hyuk Lee, Osan-si (KR); Suk-Hoon Moon, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/504,621

(22) Filed: Aug. 16, 2006

(30) Foreign Application Priority Data
Jan. 3, 2006 (KR) 10-2006-0000412

(51) Int. Cl. B67D 5/54

(52) U.S. Cl. 137/154

(57) ABSTRACT

A chemical dispensing apparatus adapted to perform a FOX process and further adapted to eliminate contamination particles from a chemical solution being dispensed on a wafer. The chemical dispensing apparatus includes a helium gas container, a first bottle, a second bottle, a first helium supply pipe, a second helium supply pipe, a first regulator, a second regulator, a first air valve, a second air valve, a first chemical supply pipe, a manual valve, a second chemical supply pipe, a filter, a flowmeter, a suck back control valve, a nozzle, a first vent line, a first pressure sensor, a first vent valve, a second pressure sensor, and a second vent valve.

### BACKGROUND AND SUMMARY

1. Technical Field

Embodiments of the present invention relate to a chemical dispensing apparatus adapted for use with a process equipment capable of forming a Flow Oxide (FOX) layer. More particularly, embodiments of the present invention relate to a chemical dispensing apparatus adapted to dispense chemical onto a wafer once potential contamination particles are removed following a FOX fabrication process.

This application claims priority to Korean Patent Application 10-2006-0000412, filed on Jan. 3, 2006, the subject matter of which is hereby incorporated by reference.

2. Description of Related Art

Semiconductor devices are manufactured on wafer substrates using a complex sequence of processes. These processes may be generally classified as related to fabrication, assembly, and test. Fabrication processes are applied to a wafer to form electrical and electromechanical circuits. Exemplary fabrication processes include those related to material layer deposition and formation, diffusion, photoresist formation, material layer etching, etc. Fabrication processes typically conclude with the completion of fully functioning “wafer-level” devices being formed on the wafer.

Among the general class of fabrication processes are various photolithography processes. Prior to many conventional photolithography processes, an oxide layer is formed to protect the working surface of a wafer being processed. A liquid photoresist solution is then dropped onto the oxide layer while the wafer is being rotated at high speed. In this manner, a photoresist layer is uniformly “spin-coated” onto the wafer. Once the wafer is coated with a photoresist layer, it is irradiated with a light having a defined wavelength through a specially prepared mask. The mask defines desired circuit patterns on the surface of the wafer by selectively exposing (and reacting) portions of the photoresist layer. Following the exposure/reaction process, the wafer is chemically developed to remove portions of the photoresist layer. A virtual image of the desired circuit patterns is thus formed on the on the surface of the wafer.

Subsequently, multiple material layers previously formed on the surface of the wafer under the photoresist layer may be selectively removed (e.g., patterned) using various etching processes. Conventional etching processes may use gas(es) or liquid chemical(s). From the foregoing summary, one may understand that the formation and patterning of the photoresist layer is a very important factor in properly defining the desired circuit patterns. Thus, the thickness and uniformity of the photoresist layer formed on the wafer are critical fabrication parameters that define, in part, the critical dimensions (CDs) of the circuit patterns.

Unfortunately, many conventional apparatuses adapted to coat a wafer with photoresist solution are prone to deposition errors caused by the presence of air bubbles within the photoresist solution. This remains a problem despite the provision within conventional apparatuses of one sensor installed before an exchange valve associated with a storage tank, and another (auxiliary) sensor connected between the exchange valve and a photoresist supply tube.

Consider, for example, the photoresist dispensing apparatus described in U.S. Pat. No. 6,332,924 B1, the subject matter of which is hereby incorporated by reference. This apparatus is indicative of a class of similar apparatuses adapted to uniformly coat a wafer with a uniform amount of photoresist under a pressure through an associated nozzle.

Processes adapted to form FOX on a wafer are also common amongst the fabrication processes used to manufacture contemporary semiconductor devices. Conventional FOX process equipment typically dispenses a defined chemical material onto a wafer. The FOX chemical is then hardened on the wafer by the application of heat. In this manner, FOX—generally a silicon dioxide material—is formed on a wafer.

Silicon dioxide is one example of a class of oxide glass materials used for various purposes (e.g., as an interlayer dielectric film) in the manufacture of semiconductor devices. The term “oxide glass” in this context should be broadly construed, and specifically includes as one example, silicon dioxides such as those commonly formed by chemical vapor deposition(CVD). While the use of oxide glass materials continues in the fabrication of semiconductor devices, certain expanding constraints upon their use are emerging. That is, improvements in the nature and quality of oxide glass materials are required in view of ever more finely detailed circuit patterns, increasing device densities, and more stringent planarization requirements.

As a result, while silicon dioxide was commonly used in earlier generations of semiconductor devices, improved oxide glass materials are now being used. For example, dopants (e.g., selected impurities) such as boron and/or phosphorus are added to the oxide glass material in order to specifically tailor the melting (or re-flow) temperature of the material. Such properties allow the oxide glass material layer to be reheated to the point of softening and reflow. Reflow advantageously flattens the surface of the oxide glass material, thereby facilitating subsequent fabrication processes.

The demand for increasingly detailed circuits and increased circuit densities mandates the formation of improved oxide glass layers capable of filling very small gaps defined between adjacent circuit elements. The presence of voids (like those caused by air bubbles) within an oxide glass layer is tolerated to a lesser and lesser degree.

As a result of the foregoing, boron phosphosilicate glass (BPSG) is now commonly used as an interlayer dielectric layer. It is able to fill small structures having aspect ratios under 6:1 and fill gaps under 0.1 micron without voids. To accomplish these highly desirable results, a BPSG layer is typically deposited at a temperature within the glass transition range of about 800 to 850° C. Following deposition, the BPSG layer is reflowed. Thus, a corresponding glass transition temperature range is an important fabrication parameter for an oxide glass material. The reflow temperature should be as low as possible in order to prevent thermal damage to the delicate components formed on a wafer being processed.

Conventionally, BPSG is formed by reacting a carrier gas, such as TEOS, TMP or PH3 and TMB or TEB, with a little of ozone in an oxygen atmosphere. This process may be performed using a plasma arc process, or a similar process performed in an ozone atmosphere at a temperature ranging from between about 350 to 600° C., or between about 700 to 850° C., depending on the corresponding pressure. Processes performed at higher pressure use a lower temperature process such as the deposition of BPSG through a combination oxidation of reactive materials when, in an assumed case of an ozone atmosphere, the pressure ranges from between about 50 to 760 Torr and the temperature ranges from between about 400 to 600° C., or the pressure ranges from between about 1 to 10 Torr and the temperature ranges from about 350 to 480° C. Alternatively, a high-temperature deposition process may be employed at a relatively low pressure of about 0.5 to 5 Torr and at a temperature of about 700 to 850° C.

With the foregoing discussion in mind, consider the apparatus illustrated in FIG. (FIG.) 1. This apparatus is exemplary in its configuration of conventional chemical dispensing apparatus adapted for use in formation of a FOX layer on a wafer.

Thus, the chemical dispensing apparatus of FIG. 1 includes a helium gas container 10 adapted to supply helium gas. A first bottle 12 stores a constituent chemical solution. A second bottle 14 stores supplemental chemical solution and feeds into first bottle 12. A first helium supply pipe 16 is connected between helium gas container 10 and first bottle 12. Asecond helium supply pipe 18 is connected between helium gas container 10 and second bottle 14. A first regulator 20 is installed on first helium supply pipe 16 to control gas pressure. A second regulator 22 is installed on second helium supply pipe 18 to control gas pressure. A first valve 24 is installed on first helium supply pipe 16 to switch the supply of helium on and off under a pressure controlled by first regulator 20 to first bottle 12. A second valve 26 is installed on second helium supply pipe 18 to switch the supply of helium on and off under a pressure controlled by second regulator 22 to second bottle 14.

A first vent line 31 is connected to first bottle 12 and a second vent line 33 is connected to second bottle 14. A first pressure sensor 28 is connected to first vent line 31 to measure pressure of first vent line 31. A first vent valve 32 is connected to first vent line 31 and vents chemical from first bottle 12. A second pressure sensor 30 is connected to second vent line 33 to measure pressure of second vent line 33. A second vent valve 34 is connected to second vent line 33 and vents chemical from second bottle 14.

A second chemical supply pipe 35 is installed between first and second bottles 12 and 14. A manual valve 36 is installed on second chemical supply pipe 35 and switches on and off the flow of supplemental chemical solution from second bottle 14 to first bottle 12 when, for example, the chemical in first bottle 12 falls below a predetermined level. A first chemical supply pipe 38 connects first bottle 12 with a nozzle 44. A flowmeter 40 is installed on first chemical supply pipe 38 and quantitatively measures the flow of chemical supplied by first bottle 12. A suck back control valve 42 is installed on first chemical supply pipe 38 and selectively applies a suck back vacuum to ensure residual drops of the chemical solution applied through nozzle 44 do not fall onto a wafer being processed. Nozzle 44 sprays the chemical supplied through first chemical supply pipe 38 onto a wafer loaded onto a spin chuck 46. The wafer is rotated while chemical is being sprayed from nozzle 44 to uniformly coat the wafer's surface.

Operation of the exemplary chemical dispensing apparatus illustrated in FIG. 1 will now be described in some additional detail.

Prior to operation, helium gas container 10 is filled with helium. When first valve 24 is opened, the helium stored in helium gas container 10 applied to first bottle 12 under pressure controlled first regulator 20. Any bubbles introduced into chemical stored in first bottle 12 by the application of helium may be removed by operation of vent valve 32.

After bubble removal, chemical stored in first bottle 12 is supplied to nozzle 44 through first supply pipe 38. Nozzle 44 sprays the chemical solution onto a wafer mounted on spin chuck 46 while spin chuck 46 rotates at a high speed to uniformly coat the wafer with chemical solution. Flowmeter 40 installed on first supply pipe 38 controls the amount of chemical supplied provided through first supply pipe 38. Suck back control valve 42 installed on first chemical supply pipe 38 operates to preclude residual drops of the chemical solution from contaminating a wafer.

As the chemical is sprayed from nozzle 44, it is depleted from first bottle 12 until it falls below a predetermined level. At this time, chemical solution stored in second bottle 14 is transferred to supplement the chemical stored in first bottle 12. This is accomplished by operating second valve 26 to provide helium from helium gas container 10 in second bottle 14 under in pressure provided through second regulator 22. Any bubbles introduced in the chemical solution stored in second bottle 14 may be removed by operation of second vent valve 34. Thereafter, when manual valve 36 is operated, the chemical solution stored in second bottle 14 may be transferred into first bottle 12. Once the chemical solution stored in second bottle 14 has been transferred into first bottle 12, second air valve 26 and manual valve 36 are closed to halt the transfer process.

Unfortunately, conventional chemical dispensing apparatuses similar to the one described in relation to FIG. 1 tend to develop solid particles at various points along the flow of chemical. For example, particles commonly formed in first and second bottles 12 and 14 and in manual valve 36. Once formed, such particles are sprayed onto a wafer through nozzle 44 and act as contamination resulting in defective circuit pattern formations.

### SUMMARY OF THE INVENTION

Embodiments of the invention provide a chemical dispensing apparatus adapted for use in the performance of a FOX process and capable of preventing the formation of fabrication processing errors resulting from the presence of contaminate particles in a chemical solution dispensed by the apparatus.

Thus, in one embodiment, the invention provides a chemical dispensing apparatus adapted for use in the performance of a flow oxide (FOX) process, the apparatus comprising; a first bottle adapted to store a chemical solution, a nozzle adapted to apply the chemical solution to a wafer, a first chemical supply pipe connecting the first bottle and the nozzle and comprising a filter adapted to remove contaminate particles from the chemical solution applied to the wafer.

In another embodiment, the invention provides a chemical dispensing apparatus adapted for use in the performance of a flow oxide (FOX) process, the apparatus comprising; a first bottle adapted to store a chemical solution, a nozzle adapted to apply the chemical solution to a wafer, a first chemical supply pipe connecting the first bottle and the nozzle and comprising a filter adapted to remove contaminate particles from the chemical solution applied to the wafer, a second bottle adapted to store supplemental chemical solution, a first helium supply pipe connected between a helium gas container and the first bottle, a second helium supply pipe connected between the helium gas container and the second bottle, a second chemical supply pipe adapted to transfer supplemental chemical solution from the second bottle to the first bottle, a manual valve installed on the second chemical supply pipe and adapted to switch on and off the transfer flow of chemical solution from the second bottle to the first bottle, a flowmeter installed on the first chemical supply pipe and adapted to measure flow of the chemical solution from the first bottle to the nozzle, and a suck back control valve installed on the first chemical supply pipe and adapted to apply a suck back vacuum to the first chemical supply pipe.

### BRIEF DESCRIPTION OF THE DRAWINGS

FIG. 1 illustrates a conventional chemical dispensing apparatus adapted for use in the performance of a FOX process; and

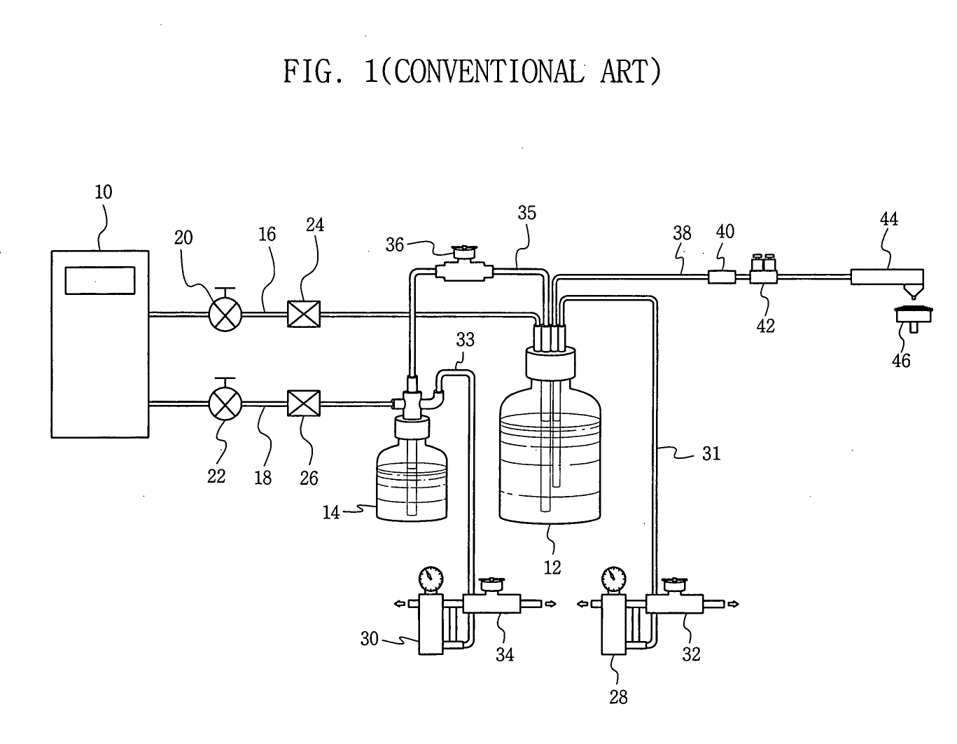

FIG. 2 illustrates a chemical dispensing apparatus adapted for use in the performance of a FOX process according to one embodiment of the invention.

### DESCRIPTION OF EMBODIMENTS

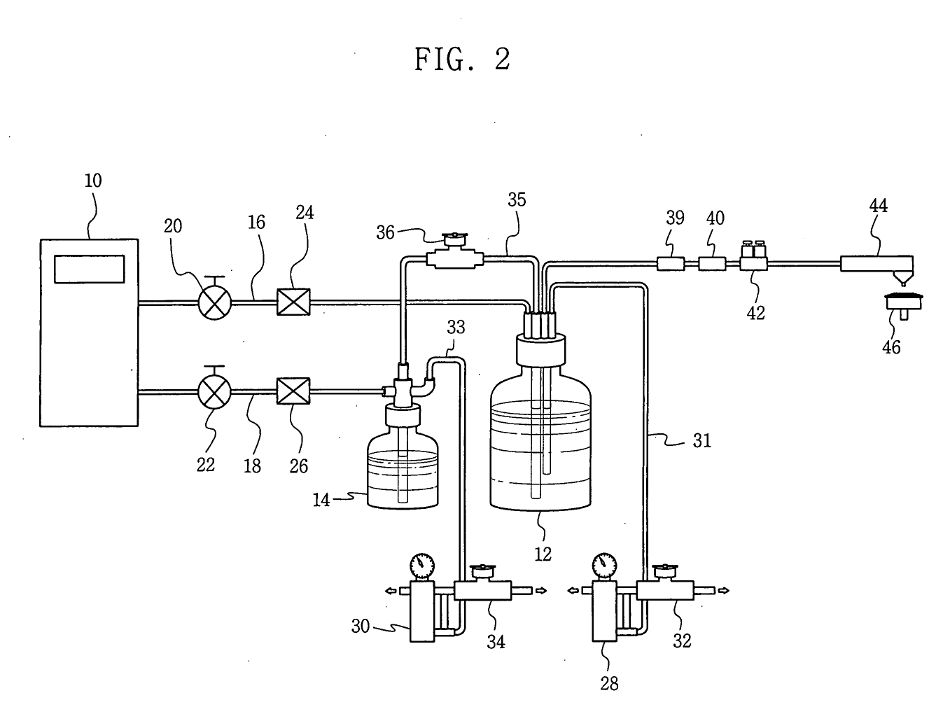

An exemplary embodiment of the present invention will now be described in some additional detail with reference to FIG. 2. It will be understood by those skilled in the art that the present invention may be variously embodied and is not limited to only the described embodiments.

FIG. 2 illustrates a chemical dispensing apparatus adapted for use in the performance of a FOX process. The chemical dispensing apparatus comprises a helium gas container 10 adapted to supply helium gas. A first bottle 12 stores a constituent chemical solution. A second bottle 14 stores supplemental chemical solution and feeds into first bottle 12. A first helium supply pipe 16 is connected between helium gas container 10 and first bottle 12. A second helium supply pipe 18 is connected between helium gas container 10 and second bottle 14. A first regulator 20 is installed on first helium supply pipe 16 to control gas pressure. A second regulator 22 is installed on second helium supply pipe 18 to control gas pressure. A first valve 24 is installed on first helium supply pipe 16 to switch the supply of helium on and off under a pressure controlled by first regulator 20 to first bottle 12. Asecond valve 26 is installed on second helium supply pipe 18 to switch the supply of helium on and off under a pressure controlled by second regulator 22 to second bottle 14.

A first vent line 31 is connected to first bottle 12 and a second vent line 33 is connected to second bottle 14. A first pressure sensor 28 is connected to first vent line 31 to measure pressure of first vent line 31. A first vent valve 32 is connected to first vent line 31 and vents chemical from first bottle 12. A second pressure sensor 30 is connected to second vent line 33 to measure pressure of second vent line 33. A second vent valve 34 is connected to second vent line 33 and vents chemical from second bottle 14.

A second chemical supply pipe 35 is installed between first and second bottles 12 and 14. A manual valve 36 is installed on second chemical supply pipe 35 and switches on and off the flow of supplemental chemical solution from second bottle 14 to first bottle 12 when, for example, the chemical in first bottle 12 falls below a predetermined level. A first chemical supply pipe 38 connects first bottle 12 with a nozzle 44. A flowmeter 40 is installed on second chemical supply pipe 38 and quantitatively measures the flow of chemical supplied by first bottle 12. A filter 39 is also installed on first chemical supply pipe 38 and is adapted to filter particles from chemical solution supplied from first bottle 12. A suck back control valve 42 is installed on first chemical supply pipe 38 and selectively applies a suck back vacuum to ensure residual drops of the chemical solution applied through nozzle 44 do not fall onto a wafer being processed. Nozzle 44 sprays the chemical supplied through first chemical supply pipe 38 onto a wafer loaded onto a spin chuck 46. The wafer is rotated while chemical is being sprayed from nozzle 44 to uniformly coat the wafer's surface.

An exemplary operation of chemical dispensing apparatus will be now described with reference to FIG. 2.

Prior to operation, helium gas container 10 is filled with helium. When first valve 24 is opened, the helium stored in helium gas container 10 applied to first bottle 12 under pressure controlled first regulator 20. Any bubbles introduced into chemical stored in first bottle 12 by the application of helium may be removed by operation of vent valve 32.

After bubble removal, chemical stored in first bottle 12 is supplied to nozzle 44 through first supply pipe 38 and through filter 39. Nozzle 44 sprays the chemical solution onto a wafer mounted on spin chuck 46 while spin chuck 46 rotates at a high speed to uniformly coat the wafer with chemical solution. Flowmeter 40 installed on first supply pipe 38 controls the amount of chemical supplied provided through first supply pipe 38. Suck back control valve 42 installed on first chemical supply pipe 38 operates to preclude residual drops of the chemical solution from contaminating a wafer.

As the chemical is sprayed from nozzle 44, it is depleted from first bottle 12 until it falls below a predetermined level. At this time, chemical solution stored in second bottle 14 is transferred to supplement the chemical stored in first bottle 12. This is accomplished by operating second valve 26 to provide helium from helium gas container 10 in second bottle 14 under pressure provided through second regulator 22. Any bubbles introduced in the chemical solution stored in second bottle 14 may be removed by operation of second vent valve 34. Thereafter, when manual valve 36 is operated, the chemical solution stored in second bottle 14 may be transferred into first bottle 12. Once the chemical solution stored in second bottle 14 has been transferred into first bottle 12, second air valve 26 and manual valve 36 are closed to halt the transfer process.

Unlike the convention chemical dispensing apparatus, the apparatus described in relation to FIG. 2 eliminates any contaminate particles arising within either one of first and second bottles 12 and 14 and manual valve 36. The elimination of contamination particles prior to application of the chemical solution to nozzle 44 markedly reduces the formation of voids and other fabrication errors on the wafer, thereby reducing fabrication defects in the electrical circuits.

In one related embodiment, second chemical supply pipe 35 is formed from a ¼ inch Teflon pipe, and first chemical supply pipe 38 is formed from a ⅛ inch Teflon pipe.

It will be apparent to those skilled in the art that modifications and variations can be made to the foregoing example without deviating from the scope of the invention. Thus, it is intended that the present invention cover any such modifications and variations of this invention provided they come within the scope of the appended claims and their equivalents.

What is claimed is:

1. A chemical dispensing apparatus adapted for use in the performance of a flow oxide (FOX) process, the apparatus comprising:
a first bottle adapted to store a chemical solution;
a nozzle adapted to apply the chemical solution to a wafer;
a first chemical supply pipe connecting the first bottle and the nozzle and comprising a filter adapted to remove contaminate particles from the chemical solution applied to the wafer.

2. The chemical dispensing apparatus of claim 1, further comprising:
a helium gas container storing helium;
a second bottle adapted to store supplemental chemical solution;
a first helium supply pipe connected between the helium gas container and the first bottle;
a first regulator installed on the first helium supply pipe and adapted to controlling pressure of helium supplied to the first bottle; and,
a first valve installed on the first helium supply pipe and adapted to switch on and off a flow of helium into the first bottle;

3. The chemical dispensing apparatus of claim 2, further comprising:
a second helium supply pipe connected between the helium gas container and the second bottle;
a second regulator installed on the second helium supply pipe and adapted to controlling pressure of helium supplied to the second bottle; and,
a second valve installed on the second helium supply pipe and adapted to switch on and off a flow of helium into the second bottle.

4. The chemical dispensing apparatus of claim 3, further comprising:
a second chemical supply pipe adapted to transfer supplemental chemical solution from the second bottle to the first bottle; and
a manual valve installed on the second chemical supply pipe and adapted to switch on and off the transfer flow of chemical solution from the second bottle to the first bottle.

5. The chemical dispensing apparatus of claim 4, further comprising:
a flowmeter installed on the first chemical supply pipe and adapted to measure flow of the chemical solution from the first bottle to the nozzle.

6. The chemical dispensing apparatus of claim 4, further comprising:
a suck back control valve installed on the first chemical supply pipe and adapted to apply a suck back vacuum to the first chemical supply pipe.

7. The chemical dispensing apparatus of claim 4, wherein the nozzle is adapted to spray the chemical solution onto the wafer.

8. The chemical dispensing apparatus of claim 4, further comprising:
a first vent line connected to the first bottle;
a first pressure sensor connected to the first vent line and adapted to measure pressure in the first vent line; and
a first vent valve connected to the first vent line and adapted to vent chemical solution from the first bottle.

9. The chemical dispensing apparatus of claim 4, further comprising:
a second vent line connected to the second bottle;
a second pressure sensor connected to the second vent line and adapted to measure pressure in the second vent line; and
a second vent valve connected to the second vent line and adapted to vent chemical solution from the second bottle.

10. A chemical dispensing apparatus adapted for use in the performance of a flow oxide (FOX) process, the apparatus comprising:
a first bottle adapted to store a chemical solution;
a nozzle adapted to apply the chemical solution to a wafer;
a first chemical supply pipe connecting the first bottle and the nozzle and comprising a filter adapted to remove contaminate particles from the chemical solution applied to the wafer;
a second bottle adapted to store supplemental chemical solution;
a first helium supply pipe connected between a helium gas container and the first bottle;
a second helium supply pipe connected between the helium gas container and the second bottle;
a second chemical supply pipe adapted to transfer supplemental chemical solution from the second bottle to the first bottle;
a manual valve install on the second chemical supply pipe and adapted to switch on and off the transfer flow of chemical solution from the second bottle to the first bottle;
a flowmeter installed on the first chemical supply pipe and adapted to measure flow of the chemical solution from the first bottle to the nozzle; and
a suck back control valve installed on the first chemical supply pipe and adapted to apply a suck back vacuum to the first chemical supply pipe.

11. The chemical dispensing apparatus of claim 10, further comprising:
a first vent line connected to the first bottle;
a first pressure sensor connected to the first vent line and adapted to measure pressure in the first vent line;
a first vent valve connected to the first vent line and adapted to vent chemical solution from the first bottle;
a second vent line connected to the second bottle;
a second pressure sensor connected to the second vent line and adapted to measure pressure in the second vent line; and
a second vent valve connected to the second vent line and adapted to vent chemical solution from the second bottle.
